(19) United States
(12) Patent Application Publication
(10) Pub. No.: US 2022/0193851 A1
(43) Pub. Date: Jun. 23, 2022

(54) METHOD AND DEVICE FOR EVALUATING PERFORMANCE STATE OF NUMERICAL CONTROL CUTTING BIT FOR FLEXIBLE MATERIALS

(71) Applicants: GUANGDONG UNIVERSITY OF TECHNOLOGY, Guangzhou (CN); Foshan Shike Intelligent Technology Co. LTD, Foshan (CN)

(72) Inventors: Yaohua DENG, GUANGZHOU (CN); Chengwang GUO, GUANGZHOU (CN); Qiwen LU, GUANGZHOU (CN)

(21) Appl. No.: 17/161,096

(22) Filed: Jan. 28, 2021

Related U.S. Application Data
(63) Continuation of application No. PCT/CN2020/137944, filed on Dec. 21, 2020.

(30) Foreign Application Priority Data
Dec. 17, 2020 (CN) 202011494943.6

(51) Int. Cl. B23Q 17/09; G05B 19/4065

(52) U.S. Cl. CPC B23Q 17/0961; G05B 2219/50276; G05B 19/4065

(57) ABSTRACT

The present invention discloses a method and device for evaluating a performance state of a numerical control cutting tool bit for flexible materials. The method includes: detecting three-phase current data of a brushless direct current motor during operation in real time by a preset current probe when the brushless direct current motor rotates to drive the numerical control cutting tool bit to vibrate; extracting characteristic values from the three-phase current data; clustering the characteristic values, and generating m real-time clusters, wherein m is an integer greater than 0; and acquiring j reference clusters, and determining a performance state level of the numerical control cutting tool bit based on the j reference clusters and the m real-time clusters, wherein j is an integer greater than 0.

### CROSS-REFERENCE TO RELATED APPLICATIONS

This application is a continuation of International Patent Application No. PCT/CN2020/137944 with a filing date of Dec. 21, 2020, designating the United States, now pending, and further claims priority to Chinese Patent Application No. 202011494943.6 with a filing date of Dec. 17, 2020. The content of the aforementioned applications, including any intervening amendments thereto, are incorporated herein by reference.

### TECHNICAL FIELD

The present invention relates to the technical field of performance evaluation, and particularly relates to a method and device for evaluating a performance state of a numerical control cutting tool bit for flexible materials.

### BACKGROUND OF THE PRESENT INVENTION

Multilayer large and thick flexible materials occupy an important place in clothing and leather cutting. Because of the advantages in cutting speed, efficiency, cutting thickness and cutting quality, a high-speed vibration cutting tool bit is used for cutting multilayer flexible materials with non-uniform thickness, flatness and adsorptivity. In an existing flexible material cutting control method, a cutting route of the tool and the moving speed of the tool on a plane can be intelligently planned according to the shape of a machining path, thereby solving a compensation problem of material machining deformation. However, on high-speed, high-precision, high-efficiency and high-utilization cutting occasions of different multilayer flexible materials, a performance degradation trend of the cutting tool bit is accelerated, and machining damage of the materials is increased, thereby decreasing machining quality. Therefore, an operating state of the cutting tool bit needs to be monitored during machining so as to intelligently adjust the movement of the tool bit, delay the performance degradation trend of the cutting tool bit and increase the stability of the machining state of the tool bit, thereby ensuring the machining quality.

However, the existing methods have problems such as unstable cutting quality and low yield caused by manual control and adjustment of the tool bit after the cutting tool bit has significantly poor performance.

### SUMMARY OF PRESENT INVENTION

The present invention provides a method and device for evaluating a performance state of a numerical control cutting tool bit for flexible materials, for solving problems in the existing methods such as unstable cutting quality and low yield caused by manual control and adjustment of the tool bit after the cutting tool bit has significantly poor performance.

The method for evaluating the performance state of the numerical control cutting tool bit for flexible materials provided in the present invention includes the following steps:

detecting three-phase current data of a motor during operation in real time by a preset current probe when the motor rotates to drive the numerical control cutting tool bit to vibrate;

extracting characteristic values from the three-phase current data;

clustering the characteristic values, and generating m real-time clusters, wherein m is an integer greater than 0; and

acquiring j reference clusters, and determining a performance state level of the numerical control cutting tool bit based on the j reference clusters and the m real-time clusters, wherein j is an integer greater than 0.

Optionally, the characteristic values include a maximum forward current peak and mean output power; and the step of extracting the characteristic values from the three-phase current data includes:

acquiring a single-phase forward current peak and a single-phase current mean square value from the three-phase current data;

calculating the maximum forward current peak of the motor in preset cycle time by the single-phase forward current peak; and

calculating the mean output power of the motor in the preset cycle time by the single-phase current mean square value.

Optionally, the step of clustering the characteristic values and generating the m real-time clusters includes:

setting a density parameter; and

clustering the characteristic values according to the density parameter, thereby obtaining the m real-time clusters.

Optionally, the step of acquiring j reference clusters and determining the performance state level of the numerical control cutting tool bit based on the j reference clusters and the m real-time clusters includes:

acquiring j reference clusters;

combining the ith real-time cluster and the jth reference cluster to form a sample set, wherein i is an integer greater than 0;

clustering the sample set to obtain target clusters;

determining a main cluster from the target clusters;

judging whether real-time cluster data in the main cluster is greater than or equal to a preset threshold value;

if so, determining that the ith real-time cluster and the jth reference cluster have the same performance state;

if not, combining the ith real-time cluster and the (j+1)th reference cluster; and re-executing the step of clustering the sample set to obtain target clusters; and

determining the performance state level of the numerical control cutting tool bit according to the performance state of the m real-time clusters.

Optionally, the method further includes a step:

adjusting output parameters of the motor according to the performance state level.

The present invention further provides a device for evaluating the performance state of the numerical control cutting tool bit for flexible materials. The device includes:

a three-phase current data detecting module, used for detecting three-phase current data of a motor during operation in real time by a preset current probe when the motor rotates to drive the numerical control cutting tool bit to vibrate;

a characteristic value extracting module, used for extracting characteristic values from the three-phase current data;

a real-time cluster generating module, used for clustering the characteristic values, and generating m real-time clusters, wherein m is an integer greater than 0; and

a performance state level determining module, used for acquiring j reference clusters, and determining a performance state level of the numerical control cutting tool bit based on the j reference clusters and the m real-time clusters, wherein j is an integer greater than 0.

Optionally, the characteristic value extracting module includes:

a single-phase forward current peak and single-phase current mean square value acquisition submodule, used for acquiring a single-phase forward current peak and a single-phase current mean square value from the three-phase current data;

a maximum forward current peak calculation submodule, used for calculating the maximum forward current peak of the motor in preset cycle time by the single-phase forward current peak; and

a mean output power calculation submodule, used for calculating the mean output power of the motor in the preset cycle time by the single-phase current mean square value.

Optionally, the real-time cluster generating module includes:

a density parameter setting submodule, used for setting a density parameter; and

a real-time cluster generating submodule, used for clustering the characteristic values according to the density parameter, thereby obtaining the m real-time clusters.

Embodiments of the present invention further provide electronic equipment. The equipment includes a processor and a storage unit.

The storage unit is used for storing program codes and transmitting the program codes to the processor.

The processor is used for executing any of the above methods for evaluating the performance state of the numerical control cutting tool bit for flexible materials according to instructions in the program codes.

Embodiments of the present invention further provide a computer readable storage medium. The computer readable storage medium is used for storing the program codes, and the program codes are used for executing any of the above methods for evaluating the performance state of the numerical control cutting tool bit for flexible materials.

Through the above technical solutions, the present invention has advantages as follows: in the present invention, the three-phase current data of the motor during operation is detected in real time by the preset current probe when the motor rotates to drive the numerical control cutting tool bit to vibrate; the characteristic values are extracted from the three-phase current data; the characteristic values are clustered, and the m real-time clusters are generated; and the j reference clusters are acquired, and the performance state level of the numerical control cutting tool bit is determined based on the j reference clusters and the m real-time clusters, thereby solving the problems in existing methods such as unstable cutting quality and low yield caused by manual control and adjustment of the tool bit after the cutting tool bit has significantly poor performance.

### DESCRIPTION OF THE DRAWINGS

To more clearly describe the technical solutions in the embodiments of the present invention or in the prior art, the drawings required to be used in the description of the embodiments or the prior art will be simply presented below. Obviously, the drawings in the following description are merely some embodiments of the present invention, and for those skilled in the art, other drawings can also be obtained according to the drawings without contributing creative labor.

FIG. 1 is an installation schematic diagram of a numerical control cutting tool bit for flexible materials provided in embodiments of the present invention and a Hall sensor;

FIG. 2 shows a method for evaluating a performance state of a numerical control cutting tool bit for flexible materials provided in an embodiment of the present invention; and

FIG. 3 is a flow chart of steps of a method for evaluating a performance state of a numerical control cutting tool bit for flexible materials provided in another embodiment of the present invention;

FIG. 4 is a flow chart of a step of determining a performance state level of a numerical control cutting tool bit provided in an embodiment of the present invention;

FIG. 5 is a flow chart of a step of determining a performance state level of a numerical control cutting tool bit based on a clustering algorithm provided in an embodiment of the present invention;

FIG. 6 is a flow chart of a process of adjusting and controlling a numerical control cutting tool bit for flexible materials provided in an embodiment of the present invention;

FIG. 7 is a structural block diagram of a device for evaluating a performance state of a numerical control cutting tool bit for flexible materials provided in an embodiment of the present invention; and

FIG. 8 is a structural schematic diagram of a system for adjusting and controlling a numerical control cutting tool bit for flexible materials provided in an embodiment of the present invention.

### DETAILED DESCRIPTION OF PREFERRED EMBODIMENTS

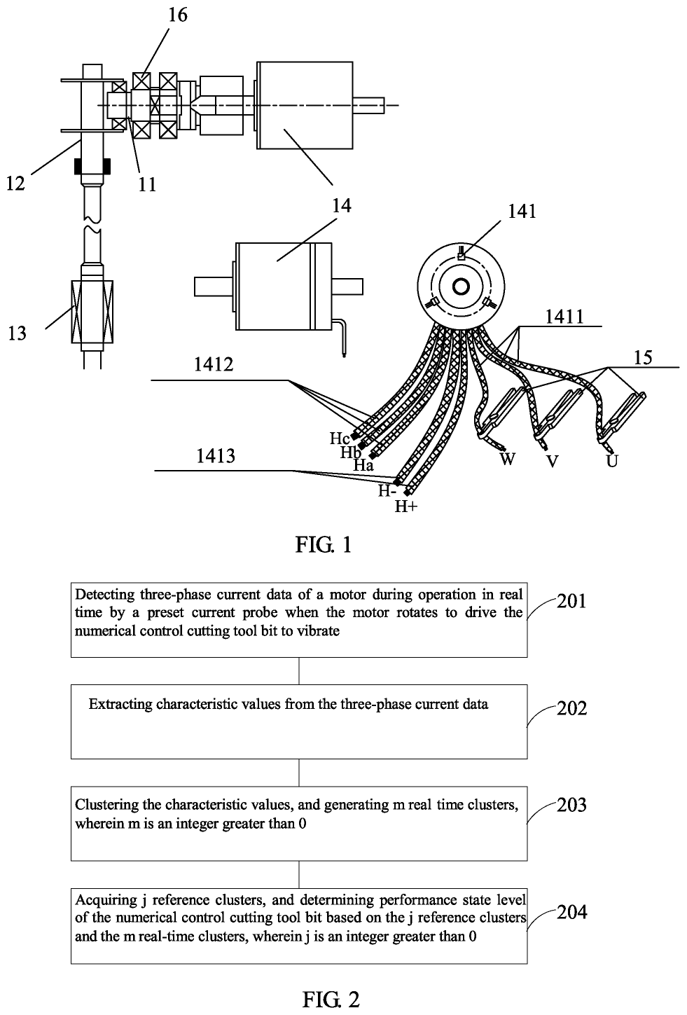

As shown in FIG. 1, a core mechanism of a numerical control cutting tool bit for flexible materials includes a cam 11, a connecting rod 12 and a sleeve 13. When the cam 11 or the connecting rod 12 bends or deforms or is asymmetric, vibration of the tool is intensified; a load torque is increased; fluctuation of the rotation speed of a motor 14 is great; commutation time of the motor 14 is prolonged; and mean output power of the motor 14 is increased. The numerical control cutting tool bit mechanism for flexible materials further includes a bearing 16.

In a process of machining materials of different thicknesses and flexibilities, the thicker the materials are, the longer the working time of the tool is; time of applying opposite force to components such as the cam 11 and the connecting rod 12 is prolonged; a forward movement speed is decreased; the rotation speed is decreased; and work done by the motor 14 rotating in one circle is increased. In addition, the opposite force applied to the tool may be affected by the flexibility of the machined materials, and fluctuation of phase current of the motor 14 may be caused. By analyzing an energy conversion relationship between the core mechanism and the motor 14, damage situations of the machined components and machined states of different machined materials may be reflected in operating data of the motor 14. A performance state of the tool can be indirectly predicted by analyzing the operating data of the motor 14, such as the mean output power and the forward current peak.

Movement of the numerical control cutting tool bit for flexible materials is as follows: a rotary motion of the brushless direct current motor 14 is converted into a linear reciprocating motion by the connecting rod 12. System efficiency of the brushless direct current motor 14 may be up to 96% or higher. Efficiency of converting electric energy into mechanical energy is high. The performance state of a mechanical structure of the tool bit can be accurately reflected by operating parameters of the motor 14. The brushless direct current motor 14 is automatically controlled to operate by a built-in Hall position sensor 141. The Hall position sensor 141 not only can detect a deflection position of a rotor of the motor, but also can be used for calculating a real-time rotation speed of the rotor and determining a commutation cycle of phase current of the motor 14. Based on these characteristics of the brushless direct current motor 14, operating state data of the motor are extremely convenient to acquire and analyzed. Current probes 15 are connected to phase current lines 1411 (including three-phase current lines such as W, V and U) of the Hall sensor 141. Three-phase current data of the motor 14 can be acquired by the current probes 15. The Hall sensor further includes three signal lines 1412 (Ha, Hb and Hc) and two power lines 1413 (H− and H+).

Based on the above principles, embodiments of the present invention provide a method and device for evaluating a performance state of a numerical control cutting tool bit for flexible materials, for solving the problems in existing methods such as unstable cutting quality and low yield caused by manual control and adjustment of the tool bit after the cutting tool bit has significantly poor performance.

To make inventive purposes, features and advantages of the present invention obvious and understandable, technical solutions in the embodiments of the present invention are clearly and fully described below in combination with drawings in the embodiments of the present invention. Apparently, embodiments described below are merely part of embodiments in the present invention, rather than all of the embodiments. Based on the embodiments in the present invention, all other embodiments obtained by those ordinary skilled in the art without making creative labor shall belong to the protection scope of the present invention.

Referring to FIG. 2, FIG. 2 shows a method for evaluating a performance state of a numerical control cutting tool bit for flexible materials provided in the embodiments of the present invention.

The method for evaluating the performance state of the numerical control cutting tool bit for flexible materials provided in the present invention may specifically include the following steps:

step 201, three-phase current data of a motor during operation was detected in real time by a preset current probe when the motor rotated to drive the numerical control cutting tool bit to vibrate;

step 202, characteristic values were extracted from the three-phase current data;

step 203, the characteristic values were clustered, and m real-time clusters were generated, wherein m was an integer greater than 0; and

step 204, j reference clusters were acquired, and a performance state level of the numerical control cutting tool bit was determined based on the j reference clusters and the m real-time clusters, wherein j was an integer greater than 0.

In the present invention, the three-phase current data of the motor during operation is detected in real time by the preset current probe when the motor rotates to drive the numerical control cutting tool bit to vibrate; the characteristic values are extracted from the three-phase current data; the characteristic values are clustered, and the m real-time clusters are generated; and the j reference clusters are acquired, and the performance state level of the numerical control cutting tool bit is determined based on the j reference clusters and the m real-time clusters, thereby solving the problems in existing methods such as unstable cutting quality and low yield caused by manual control and adjustment of the tool bit after the cutting tool bit has significantly poor performance.

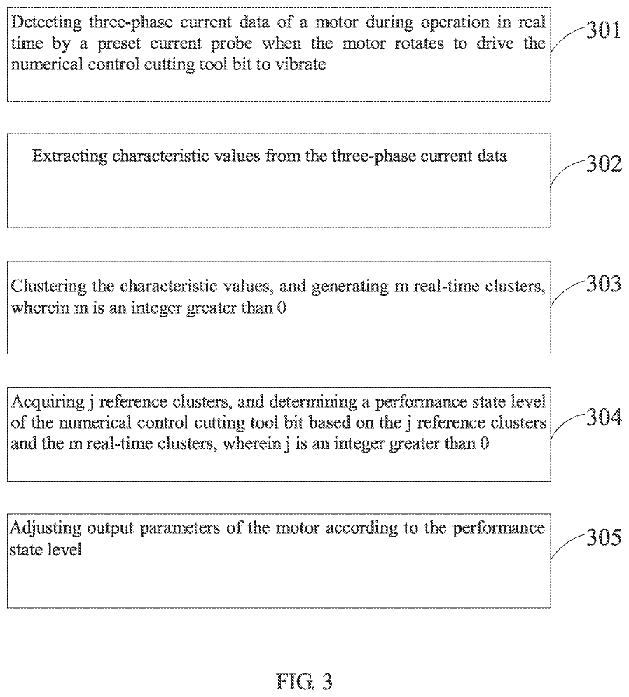

Referring to FIG. 3, FIG. 3 is a flow chart of steps of a method for evaluating a performance state of a numerical control cutting tool bit for flexible materials provided in another embodiment of the present invention. The method may specifically include the following steps:

Step 301, three-phase current data of a motor during operation was detected in real time by a preset current probe when the motor rotated to drive the numerical control cutting tool bit to vibrate.

In the embodiments of the present invention, the motor is a coreless brushless direct current motor (the coreless brushless direct current motor includes the following parameters: a rotation speed of 10000-18000 rpm, rated current of 5 A and rated power of 110 W); and the three-phase current data can be acquired by the current probe (in one example, an output variable ratio of the current probe may be up to 5 A/320 mV; amplitude precision may be 0.5%; and a bandwidth may be 30 Hz-5 kHz).

Step 302, characteristic values were extracted from the three-phase current data.

In the embodiments of the present invention, the basis of extracting the characteristic data is as follows:

1, mean output power of the motor: performance state change-load change-phase current change-mean output power change of the motor, i.e., the mean output power of the motor can reflect power consumption needed by machining of the tool and further reflect a degree of wear of the tool (the essence of the mean output power of the motor is a mean square value of the three-phase current in a circular power cycle);

2, sudden anomaly of the tool-sudden load change-sudden rotation speed change-sudden change of counter electromotive force-sudden change of phase current peak, i.e., the forward current peak of the phase current can reflect a sudden change amplitude of the current and further reflect machining stability of the tool; and

3, a performance state level of the tool can be evaluated by comprehensively considering the wear degree and machining stability of the tool.

According to the above basis, the characteristic values may include a maximum forward current peak and mean output power; and the step 302 may include:

a single-phase forward current peak and a single-phase current mean square value were acquired from the three-phase current data;

the maximum forward current peak of the motor in preset cycle time was calculated by the single-phase forward current peak; and

the mean output power of the motor in the preset cycle time was calculated by the single-phase current mean square value.

In a specific implementation, assuming that time of cyclically changing the three-phase current was τ, power-on time of single-phase forward current was τₚₕₐₛₑ,phase=a,b,c, τₐ=τ_{b}=τ_{c}=τ, and a sampling frequency of the current probe was f. Each three-phase current data set in a cycle of τ was calculated and screened as follows (τ,τₐ,τ_{b},τ_{c} were determined by time intervals of output signals of the Hall position sensor):

1, single-phase forward current peaks such as Iₘₐₓ^{a}, Iₘₐₓ^{b} and Iₘₐₓ^{c} of each phase were screened, wherein Iₘₐₓ^{phase}=max(i₁^{phase},i₂^{phase}, . . . , i_{[fτ}_{ₚₕₐₛₑ}_{]}^{phase}),phase=a,b,c; iₚ^{phase} was the pth sampling current value; and p=1,2, . . . , [fτₚₕₐₛₑ];

2, mean square values such as P̅ₐ, P̅_{b} and P̅_{c} of current of each phase were screened, wherein

$${\overline{P}}_{phase} = \frac{1}{[ f {τ}_{phase} ]} {\sum }_{p = 1}^{[ f {τ}_{phase} ]} {( {i}_{p}^{phase} )}^{2} ;$$

and

3, the mean output power P̅ₘᵢₓ and the maximum forward current peak Iₘₐₓ of the motor in the time τ were calculated, wherein,

P̅ₘᵢₓ=P̅ₐ=P̅_{b}=P̅_{c}:

Iₘₐₓ=max(Iₘₐₓ^{a}, Iₘₐₓ^{b}, Iₘₐₓ^{c})

Step 303, the characteristic values were clustered, and in real-time clusters were generated.

In one example, the step 303 may include the following sub-steps:

a density parameter was set; and

the characteristic values were clustered according to the density parameter, thereby obtaining the m real-time clusters.

Specifically, the method of constructing the real-time clusters is as follows:

1, two density parameters were automatically set as follows: a clustering radius ε₀ and a core point judgment threshold M;

2, a sample instance xₜ was randomly selected from a training sample set θ (the selected sample was not re-selected any more); and a Euclidean distance between the instance and the rest sample instances in the sample set was calculated;

3, judgment:

I, the calculated Euclidean distance between the two instances was in a circle that took the instance xₜ as the center of the circle and took ε₀ as the radius;

II, the number of the sample instances in the circle was more than or equal to M;

if both the I and II were met, the xₜ was set as a dense point, and whether the circle that took the instance xₜ as the center of the circle included the set clusters was judged; if included, the xₜ was included in the set clusters; if not, a new cluster was set;

if only the I was met but the II was not met, and the included points had no dense point, the xₜ was set as a peripheral point; if the included points had the dense point, the xₜ was set as a boundary point having the same cluster as the dense point; and

if neither I, nor II was met, the xₜ was set as a peripheral point;

4, if the xₜ was judged as the dense point, for the rest points included in the circle that took the instance xₜ as the center of the circle and took ε₀ as the radius, the step 3 was iteratively repeated;

5, if the instance that had been set as the peripheral point was judged as the boundary point of a certain cluster in the subsequent process, the instance was modified as the boundary point of the cluster; and

6, the above steps were repeated until all the samples in the set θ were traversed.

Step 304, j reference clusters were acquired, and a performance state level of the numerical control cutting tool bit was determined based on the j reference clusters and the m real-time clusters, wherein j was an integer greater than 0.

In the embodiments of the present invention, a process of constructing the reference clusters was as follows:

1, setting a training sample set: K performance state levels were determined according to damage degrees of the cam or the connecting rod (such as bending, deformation or asymmetry); the performance: state level was a sample label πₖ; k=1,2, . . . , K; the mean output power value P̅ₘᵢₓ of the motor served as the first characteristic value x₍₁₎ of the samples; the maximum forward current peak Iₘₐₓ served as the second characteristic value x⁽²⁾ of the samples; the quantity of the samples was set as T; and a sample data set may be represented as:

θ={(x₁,y₁), (x₂,y₂), . . . , (x_{T},y_{T})}

wherein (xₜ,yₜ) represented sample data corresponding to the tth circular current power-on time τₜ; xₜ=(xₜ⁽¹⁾,xₜ⁽²⁾) represented the tth input sample instance; xₜ⁽¹⁾ represented the first characteristic value of the tth input sample instance; yₜ=πₖ represented a category πₖ of the tth input sample instance; and t=1,2, . . . , T;

2, setting a number of training samples: the T training samples shall meet: the quantity of the training samples having a performance state level of πₖ was set as Qₖ, i.e.,

$$\frac{\vert {Q}_{k} - {Q}_{l} \vert}{min ( {Q}_{k} , {Q}_{l} )} \leq 20 \% , ( k , l = 1 , 2 , … K )$$

$${\sum }_{k = 1}^{K} {Q}_{k} = {\sum }_{l = 1}^{K} {Q}_{l} = T$$

3, constructing reference clusters according to the method of constructing the real-time clusters:

an initial radius

$${ɛ}_{0} = \frac{\sqrt{{( {x}_{max}^{( 1 )} - {x}_{min}^{( 1 )} )}^{2} + {( {x}_{max}^{( 2 )} - {x}_{min}^{( 2 )} )}^{2}}}{2}$$

of the reference clusters was set, wherein xₘₐₓ⁽¹⁾ and xₘᵢₙ⁽¹⁾ represented the maximum and minimum of the first characteristic value (the mean output power of the motor) in the training samples T, and xₘₐₓ⁽²⁾ and xₘᵢₙ⁽²⁾ represented the maximum and minimum of the second characteristic value (forward current peak) in the training samples T; an initial dense point judgment threshold was set as M₀=2K; the T training samples θ were clustered by an initial density parameter (0, ε₀, M₀); and an optimal clustering parameter (C, ε, M) was solved according to a following objective function, wherein C was the number of the formed clusters, ε was the clustering radius, and M was the dense point judgment threshold:

$$argmax ( {\sum }_{k = 1}^{K} \frac{I ( {C}_{k} = {π}_{k} )}{{Q}_{k}} )$$

$$s . t . C = K$$

$$\frac{I ( {C}_{k} = {π}_{k} )}{{Q}_{k}} \geq 70 \%$$

$$0 \leq ɛ \leq {ɛ}_{0}$$

$$M \geq 2 K$$

After the reference clusters are acquired, the performance state level of the numerical control cutting tool bit can be determined based on the real-time clusters and the reference clusters.

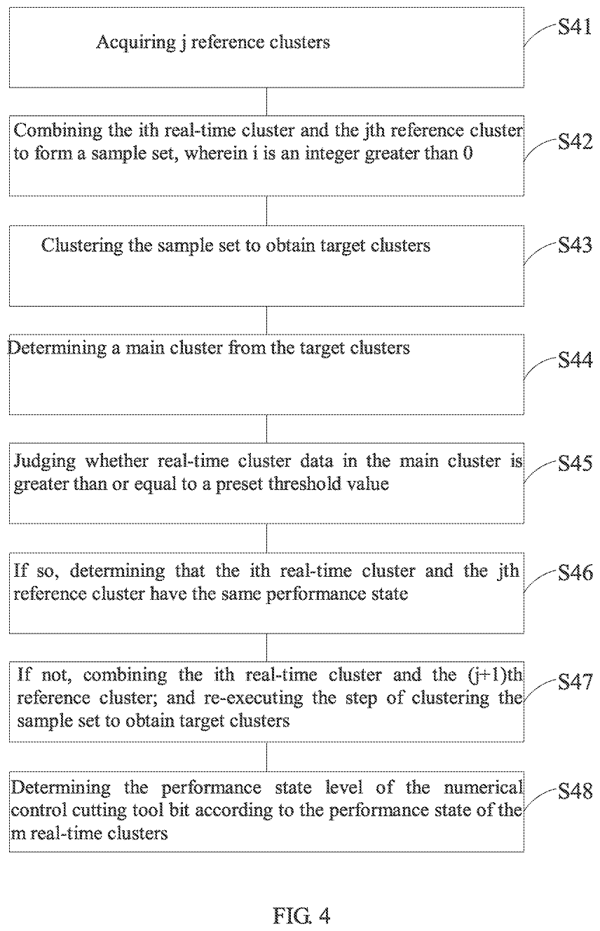

In one example, as shown in FIG. 4, the step 304 may specifically include the following sub-steps:

S41, j reference clusters were acquired;

S42, the ith real-time duster and the jth reference cluster were combined to form a sample set, wherein i was an integer greater than 0;

S43, the sample set was clustered to obtain target clusters;

S44, a main cluster was determined from the target clusters;

S45, whether real-time cluster data in the main cluster was greater than or equal to a preset threshold value was judged;

S46, if so, it was determined that the ith real-time cluster and the jth reference cluster had the same performance state;

S47, if not, the ith real-time cluster and the (j+1)th reference cluster were combined; and the step of clustering the sample set was re-executed to obtain target clusters; and

S48, the performance state level of the numerical control cutting tool bit was determined according to the performance state of the in real-time clusters.

In a specific implementation, during actual operation, the mean motor output power data and the maximum forward current peak data N cycles (N≤min(Qₖ)) in continuous machining scenarios were acquired; the data were divided into m real-time clusters by a clustering algorithm (density parameters of the actual operating data were as follows: a clustering radius of εᵣ=1.5ε, and a dense point judgment threshold of Mᵣ=M), wherein in was any positive integer; the quantity of data included in the ith real-time cluster was Nᵢ, i=1,2, . . . , m, Σᵢ₌₁^{m} Nᵢ=N.

The m real-time clusters and C reference clusters were clustered according to the density parameter (C, ε, M in sequence; and the process was as follows: the ith real-time cluster and the jth reference cluster were combined into one sample (i=1,2, . . . , m, f=1,2, . . . , K), re-clustering was conducted, and a performance state level of the newly formed target clusters was judged under following conditions:

1) a cluster in which original reference cluster data existed was a main cluster;

2) whether the quantity Dᵢⱼ of operating sample data included in the main cluster was more than or equal to 60% Nᵢ was judged; if so, it was defined that, a performance state corresponding to data of the ith real-time cluster in the actual operating data was the same as that of the jth reference cluster;

3) if the quantity Dᵢⱼ was less than or equal to 60% Nᵢ, the ith real-time cluster and the (j+1)th reference cluster were contrasted until the Dᵢⱼ was more than or equal to 60% Nᵢ or all the C reference clusters were traversed;

4) if all the reference clusters were traversed, and the quantity Dᵢⱼ was still less than or equal to 60% Nᵢ, the max (Pᵢⱼ) in all the clusters served as the performance state of the ith real-time cluster; and

5) the above steps were executed on all the in real-time clusters until the clusters were totally traversed, and a final performance state determination method was as follows:

$$H = \frac{{Σ}_{i}^{m} {N}_{i} {A}_{j} max ( {P}_{ij} )}{{Σ}_{i}^{m} {N}_{i} max ( {P}_{ij} )} , j = 1 , 2 … , K$$

wherein Nᵢ was the quantity of the data in the tilt real-time cluster; Aⱼ was a performance state weight of the jth reference cluster; weights of the performance states 1-K were specified as (1, 2, . . . , K) the higher the score was, the more severe the deviation degree from a normal performance state was; H was a performance state evaluation index, the greater the result was, the more severe the deviation degree from the normal performance state was;

$${P}_{ij} = \frac{{D}_{ij}}{{N}_{i}}$$

represented a ratio of the ith real-time cluster included in the jth reference cluster to the total quantity of the ith real-time cluster; max (Pᵢⱼ) was the highest probability of the operating data in different reference clusters; when 60% was reached, max (Pᵢⱼ) was equal to 60%, and when 60% was not up to 60%,

$$max ( {P}_{ij} ) = max ( \frac{{D}_{ij}}{{N}_{i}} ) , j = 1 , 2 , … , K ,$$

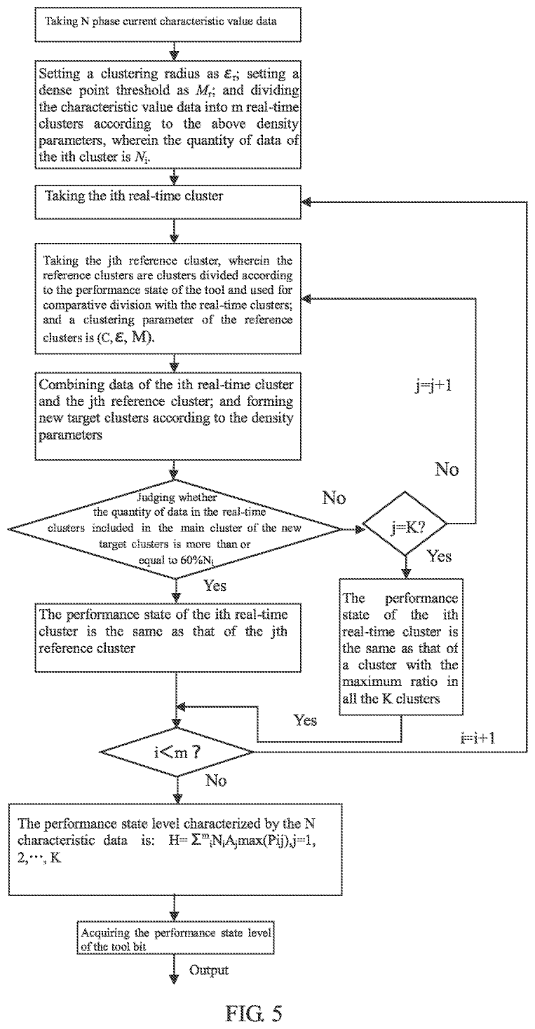

i.e., the maximum. Specific procedures were seen in FIG. 5.

Step 305, an output parameter of the motor was adjusted according to the performance state level.

In an actual application, an output voltage was correspondingly adjusted according to the analyzed performance state level; and a mean output voltage was adjusted by adjusting a PWM duty cycle, thereby controlling a vibration frequency of the tool bit according to the performance state level (the greater the damage is, the smaller the duty cycle is; vibration is decreased; and precision is ensured).

Through the embodiments of the present invention, the performance state of the tool can be judged; compensation control is performed according to the performance state, thereby greatly ensuring machining accuracy of the flexible materials in high-speed machining scenarios and prolonging service life of the tool; the density is taken as the clustering basis, which is not limited to the initial value and specific clustering shapes, and distribution of the operating data of the tool and the motor can be accurately characterized; and the sensors are contactless current probes and the Hall sensor on the motor. Thus, data acquisition is convenient and normal operations of the tool are not affected.

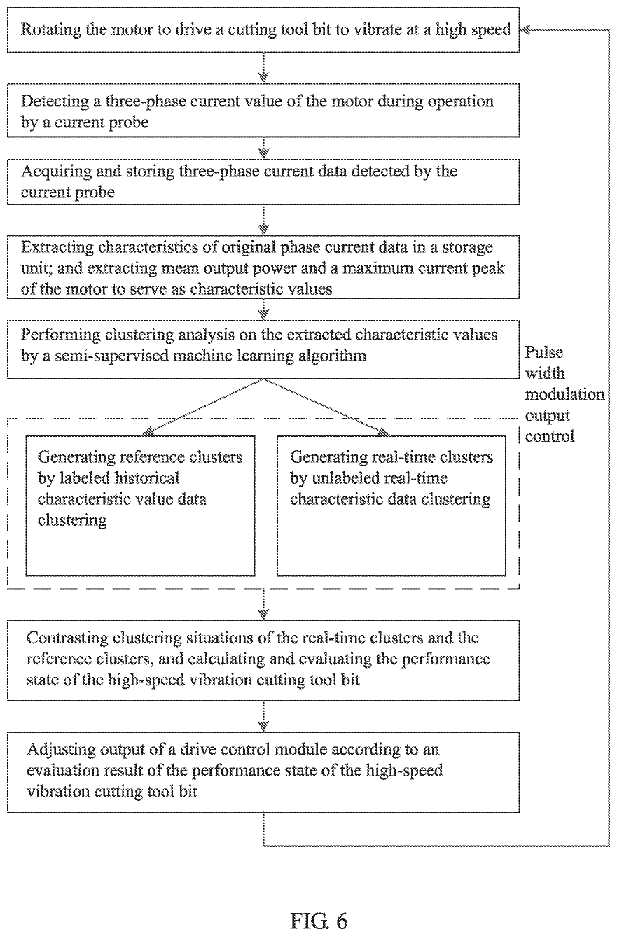

For the convenience of understanding, please refer to FIG. 6. The embodiments of the present invention are described below by virtue of specific examples. Specific steps are as follows:

A motor rotated to drive a cutting tool bit to vibrate at a high speed;

a three-phase current value of the motor during operation was detected by a current probe;

three-phase current data detected by the current probe was acquired and stored;

characteristics of original phase current data in a storage unit were extracted; and mean output power and a maximum current peak of the motor were extracted to serve as characteristic values;

the extracted characteristic values were subjected to clustering analysis by a semi-supervised machine learning algorithm, including: reference clusters were generated by labeled historical characteristic value data clustering; and real-time clusters were generated by unlabeled real-time characteristic data clustering;

clustering situations of the real-time clusters and the reference clusters were contrasted, and the performance state of the high-speed vibration cutting tool bit was calculated and evaluated;

the output of a drive control module was adjusted according to an evaluation result of the performance state of the high-speed vibration cutting tool bit; and

the output of the motor was controlled by pulse width modulation output.

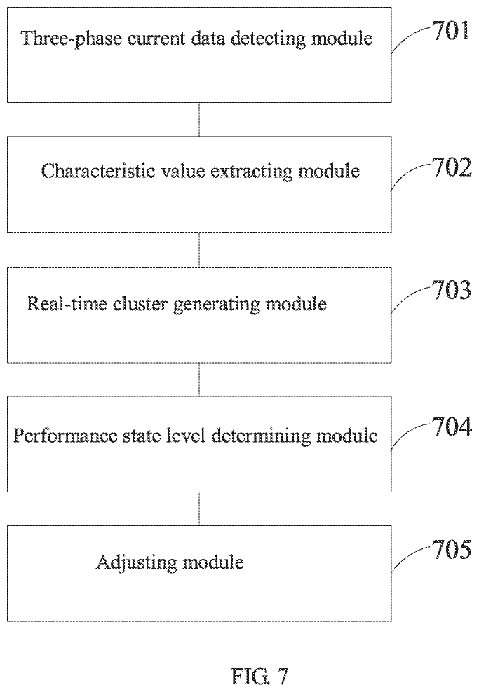

By referring to FIG. 7, FIG. 7 is a structural block diagram of a device for evaluating a performance state of a numerical control cutting tool bit for flexible materials provided in embodiments of the present invention.

The embodiments of the present invention provide a device for evaluating the performance state of the numerical control cutting tool bit for flexible materials. The device includes:

a three-phase current data detecting module 701, used for detecting three-phase current data of a motor during operation in real time by a preset current probe when the motor rotates to drive the numerical control cutting tool bit to vibrate;

a characteristic value extracting module 702, used for extracting characteristic values from the three-phase current data;

a real-time cluster generating module 703, used for clustering the characteristic values, and generating m real-time clusters, wherein m is an integer greater than 0; and

a performance state level determining module 704, used for acquiring j reference clusters, and determining a performance state level of the numerical control cutting tool bit based on the j reference clusters and the m real-time clusters, wherein j is an integer greater than 0.

In the embodiments of the present invention, the characteristic value extracting module 702 includes:

a single-phase forward current peak and single-phase current mean square value acquisition submodule, used for acquiring a single-phase forward current peak and a single-phase current mean square value from the three-phase current data;

a maximum forward current peak calculation submodule, used for calculating the maximum forward current peak of the motor in preset cycle time by the single-phase forward current peak; and

a mean output power calculation submodule, used for calculating the mean output power of the motor in the preset cycle time by the single-phase current mean square value.

In the embodiments of the present invention, the real-time cluster generating module 703 includes:

a density parameter setting submodule, used for setting a density parameter; and

a real-time cluster generating submodule, used for clustering the characteristic values according to the density parameter, thereby obtaining the m real-time clusters.

In the embodiments of the present invention, the performance state level determining module 704 includes:

a reference cluster acquisition submodule, used for acquiring j reference clusters;

a sample set formation submodule, used for combining the ith real-time cluster and the jth reference cluster to form a sample set, wherein i is an integer greater than 0;

a target cluster acquisition submodule, used for clustering the sample set to obtain target clusters;

a main cluster determination submodule, used for determining a main cluster from the target clusters;

a judgment submodule, used for judging whether real-time cluster data in the main cluster is greater than or equal to a preset threshold value; if so, determining that the ith real-time cluster and the jth reference cluster have the same performance state; if not, combining the ith real-time cluster and the (j+1)th reference cluster; and re-executing the step of clustering the sample set to obtain target clusters; and

a performance state level determination submodule, used for determining the performance state level of the numerical control cutting tool bit according to the performance state of the m real-time clusters.

In the embodiments of the present invention, the device further includes:

an adjusting module 705, used for adjusting output parameters of the motor according to the performance state level.

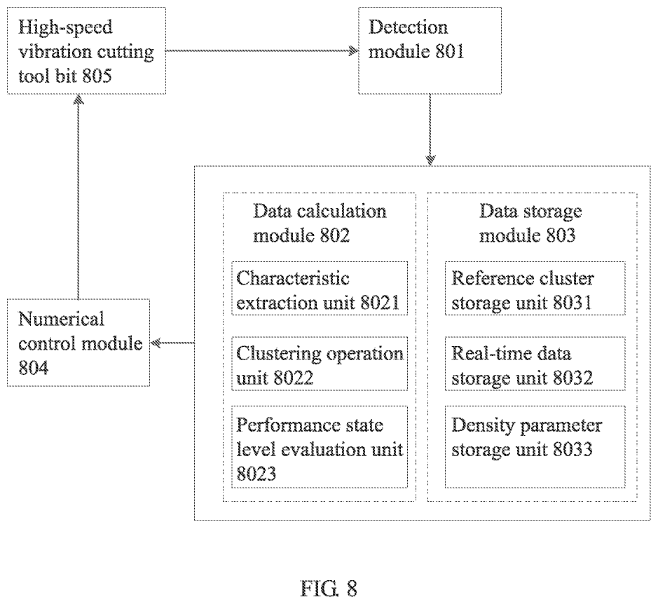

Referring to FIG. 8, based on the above method, the present invention further provides a control system of a numerical control cutting tool bit for flexible materials, used for controlling the numerical control cutting tool bit based on the performance state.

The system includes:

a detection module 801: used for detecting operating data (three-phase current data) of a drive motor of a high-speed vibration cutting tool bit 805;

a data calculation module 802, used for executing calculation, analysis and other tasks in a method implementation process;

a data storage module 803: used for storing data and parameters in the method implementation process; and

a numerical control module 804: used for controlling pulse width modulation output.

The data calculation module 802 includes a characteristic extraction unit 8021, a clustering operation unit 8022 and a performance state level evaluation unit 8023.

The characteristic extraction unit 8021 is used for extracting needed characteristic values from acquired motor operating data.

The clustering operation unit 8022 is used for conducting clustering operation on the extracted characteristic sample set to form multiple clusters.

The performance state level evaluation unit 8023 is used for evaluating performance state levels according to clustered results.

The data storage module 803 includes a reference cluster storage unit 8031, a real-time data storage unit 8032 and a density parameter storage unit 8033.

The reference cluster storage unit 8031 is used for storing training sample data corresponding to the trained cluster data set.

The real-time data storage unit 8032 is used for storing intercepted real-time data and cluster data formed by real-time data clustering.

The density parameter storage unit 8033 is used for storing density parameters adopted during clustering.

The embodiments of the present invention further provide electronic equipment, including a processor and a storage unit.

The storage unit is used for storing program codes and transmitting the program codes to the processor.

The processor is used for executing the method for evaluating the performance state of the numerical control cutting tool bit for flexible materials in the embodiments of the present invention according to instructions in the program codes.

The embodiments of the present invention further provide a computer readable storage medium. The computer readable storage medium is used for storing the program codes, and the program codes are used for executing the method for evaluating the performance state of the numerical control cutting tool bit for flexible materials in the embodiments of the present invention.

Those skilled in the art can clearly understand that for convenience and simplicity of description, the specific working processes of the system, device and unit described above can refer to the corresponding processes in the embodiments of the method described above, and will not be repeated herein.

Each embodiment in the description is described in a progressive way. The difference of each embodiment from each other is the focus of explanation. The same and similar parts among all of the embodiments can be referred to each other.

Those skilled in the art should understand that the embodiments of the present invention can provide a method, apparatus or computer program product. Therefore, the embodiments of the present invention can adopt a form of a full hardware embodiment, a full software embodiment or an embodiment combining software and hardware. Moreover, the embodiments of the present invention can adopt a form of a computer program product capable of being implemented on one or more computer available storage media (including but not limited to disk memory, CD-ROM, optical memory, etc.) containing computer available program codes.

The embodiments of the present invention are described with reference to flow diagrams and/or block diagrams according to the method, terminal device (system) and computer program product in embodiments of the present invention. It should be understood that each flow and/or block in the flow diagrams and/or block diagrams and a combination of flows and/or blocks in the flow diagrams and/or block diagrams can be realized through computer program instructions. The computer program instructions can be provided for a processor of a general-purpose computer, a special-purpose computer, an embedded processor, or other programmable data processing terminal devices to generate a machine, so that a device for realizing designated functions in one or more flows of the flow charts and/or one or more blocks of the block diagrams is generated through the instructions executed by the processor of the computer or other programmable data processing terminal devices.

The computer program instructions can also be stored in a computer readable memory which can guide the computer or other programmable data processing terminal devices to operate in a special mode, so that the instructions stored in the computer readable memory generate a manufactured product including an instruction device, the instruction device realizing designated functions in one or more flows of the flow diagrams and/or one or more blocks of the block diagrams.

The computer program instructions can also be loaded on the computer or other programmable data processing terminal devices, so that a series of operation steps are executed on the computer or other programmable terminal devices to generate processing realized by the computer. Therefore, the instructions executed on the computer or other programmable terminal devices provide steps for realizing designated functions in one or more flows of the flow diagrams and/or one or more blocks of the block diagrams.

Although preferred embodiments in the embodiments of the present invention are described, those skilled in the art can make additional alterations and amendments to the embodiments once knowing basic creative concepts. Therefore, the appended claims are interpreted to include the preferred embodiments and all the alterations and amendments which fall into the scope of the embodiments of the present invention.

It should be finally noted that relationship terms of “first”, “second” and the like herein are just used for differentiating one entity or operation from the other entity or operation, and do not necessarily require or imply any practical relationship or sequence between the entities or operations. Moreover, terms of “comprise”, “include” or any other variant are intended to cover non-exclusive inclusion, so that a process, a method, an article or a terminal device which includes a series of elements not only includes such elements, but also includes other elements not listed clearly or also includes inherent elements in the process, the method, the article or the terminal device. Under the condition of no more limitation, the elements defined by a sentence “include one . . . ” do not exclude additional identical elements in the process, the method, the article or the terminal device which includes the elements.

As described above, the above embodiments are only used for describing the technical solution of the present invention rather than limiting the technical solution. Although the present invention is described in detail by referring to the above embodiments, those ordinary skilled in the art should understand that: the technical solution recorded in each of the above embodiments can be still amended, or some technical features therein can be replaced equivalently. However, these amendments or replacements do not enable the essence of the corresponding technical solution to depart from the spirit and the scope of the technical solution of various embodiments of the present invention.

We claim:

1. A method for evaluating a performance state of a numerical control cutting tool bit for flexible materials, comprising:
detecting three-phase current data of a motor during operation in real time by a preset current probe when the motor rotates to drive the numerical control cutting tool bit to vibrate;
extracting characteristic values from the three-phase current data;
clustering the characteristic values, and generating m real-time clusters, wherein m is an integer greater than 0; and
acquiring j reference clusters, and determining a performance state level of the numerical control cutting tool bit based on the j reference clusters and the m real-time clusters, wherein j is an integer greater than 0.

2. The method according to claim 1, wherein the characteristic values comprise a maximum forward current peak and mean output power; and the step of extracting the characteristic values from the three-phase current data comprises:
acquiring a single-phase forward current peak and a single-phase current mean square value from the three-phase current data;
calculating the maximum forward current peak of the motor in preset cycle time by the single-phase forward current peak; and
calculating the mean output power of the motor in the preset cycle time by the single-phase current mean square value.

3. The method according to claim 1, wherein the step of clustering the characteristic values and generating the m real-time clusters comprises:
setting a density parameter; and
clustering the characteristic values according to the density parameter, thereby obtaining the m real-time clusters.

4. The method according to claim 1, wherein the step of acquiring j reference clusters and determining the performance state level of the numerical control cutting tool bit based on the j reference clusters and the m real-time clusters comprises:
acquiring j reference clusters;
combining the ith real-time cluster and the jth reference cluster to form a sample set, wherein i is an integer greater than 0;
clustering the sample set to obtain target clusters;
determining a main cluster from the target clusters;
judging whether real-time cluster data in the main cluster is greater than or equal to a preset threshold value;
if so, determining that the ith real-time cluster and the jth reference cluster have the same performance state;
if not, combining the ith real-time cluster and the (j+1)th reference cluster; and re-executing the step of clustering the sample set to obtain target clusters; and
determining the performance state level of the numerical control cutting tool bit according to the performance state of the m real-time clusters.

5. The method according to claim 1, wherein the method further comprises:
adjusting output parameters of the motor according to the performance state level.

6. A device for evaluating a performance state of a numerical control cutting tool bit for flexible materials, comprising:
a three-phase current data detecting module, used for detecting three-phase current data of a motor during operation in real time by a preset current probe when the motor rotates to drive the numerical control cutting tool bit to vibrate;
a characteristic value extracting module, used for extracting characteristic values from the three-phase current data;
a real-time cluster generating module, used for clustering the characteristic values, and generating m real-time clusters, wherein m is an integer greater than 0; and
a performance state level determining module, used for acquiring j reference clusters, and determining a performance state level of the numerical control cutting tool bit based on the j reference clusters and the m real-time clusters, wherein j is an integer greater than 0.

7. The device according to claim 6, wherein the characteristic value extracting module comprises:
a single-phase forward current peak and single-phase current mean square value acquisition submodule, used for acquiring a single-phase forward current peak and a single-phase current mean square value from the three-phase current data;
a maximum forward current peak calculation submodule, used for calculating the maximum forward current peak of the motor in preset cycle time by the single-phase forward current peak; and
a mean output power calculation submodule, used for calculating the mean output power of the motor in the preset cycle time by the single-phase current mean square value.

8. The device according to claim 6, wherein the real-time cluster generating module comprises:
a density parameter setting submodule, used for setting a density parameter; and
a real-time cluster generating submodule, used for clustering the characteristic values according to the density parameter, thereby obtaining the m real-time clusters.

9. An electronic equipment, comprising a processor and a storage unit, wherein
the storage unit is used for storing program codes and transmitting the program codes to the processor; and
the processor is used for executing the method for evaluating the performance state of the numerical control cutting tool bit for flexible materials of claim 1 according to instructions in the program codes.
